(19) United States
(12) Patent Application Publication
(10) Pub. No.: US 2005/0254782 A1
(43) Pub. Date: Nov. 17, 2005

(54) Method and device of editing video data

(76) Inventor: Shu-Fang Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/845,218

(22) Filed: May 14, 2004

(51) Int. Cl. H04N 5/76; G11B 27/00

(52) U.S. Cl. 386/52; 386/55

(57) ABSTRACT

A method and device of editing video data are provided for outputting video data with good quality. When some unimportant data or data with poor quality are embedded within a video signal, they would be sifted from the video signal with a trimming or dropping step during editing. The descriptors charactering the video signal are acquired and applied on the trimming or dropping for outputting the video data with good quality.

### FIELD OF THE INVENTION

The invention relates generally to computer generation of video production. In particular, the invention relates to automatic editing of video production.

### BACKGROUND OF THE INVENTION

With the increasing use of video and storage of events and communication via video, video users and managers are confronted with additional tasks of storing, accessing, determining important scenes or frames, and summarizing videos in the most efficient manner.

In general, techniques exist to automatically segment video into component shots of a video or motion image, typically by finding the large frame differences that correspond to cuts, or shot boundaries. In many applications it is desirable to automatically create a summary or “skim” of an existing video, motion picture, or broadcast. This can be cone by selectively discarding or de-emphasizing redundant information in the video. For example, repeated shots need not be included if they are similar to shots already shown.

For example, for video summarization, video is partitioned into segments and the segments are clustered according to similarity to each other. The segment closest to the center of each cluster is chosen as the representative segment for the entire cluster. Other video summarization approaches attempt to summarize video using various heuristics typically derived analysis of closed captions accompanying the video. These approaches rely on video segmentation, or require either clustering or training.

However, some other tools built for browsing the content of a video are known, but only provide inefficient summarization or merely display a video in sequence “as it is”.

### SUMMARY OF THE INVENTION

A method and device of editing video data is provided for outputting video production with an easy way. An automatically video construct technology can help users to create video output easily.

A video outputting with better video quality is provided. With trimming some frames or dropping some shots, each video segment is acquired with good qualities and quantities of the frames or shots.

A method and device of editing video data to generate video production is provided. With dropping some segments, the video data output with the segments with good qualities.

Accordingly, one embodiment of the present invention provides a method and device of editing video data for outputting video data with good quality. When some unimportant video segments or frames with poor quality are embedded within a video signal, they would be sifted from the video signal with a dropping or trimming step during editing. The descriptors charactering the video segments and weights based on these descriptors are acquired and applied on the trimming or dropping for outputting the video data with good quality.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic flow chart illustrating one embodiment in accordance with the present invention;

FIG. 2 is a schematic block diagram illustrating video data editing system of one embodiment in accordance with this invention; and

FIG. 3 is a diagram illustrating the video segment versus corresponding segment score in according with the invention.

### DETAILED DESCRIPTION OF THE EMBODIMENTS

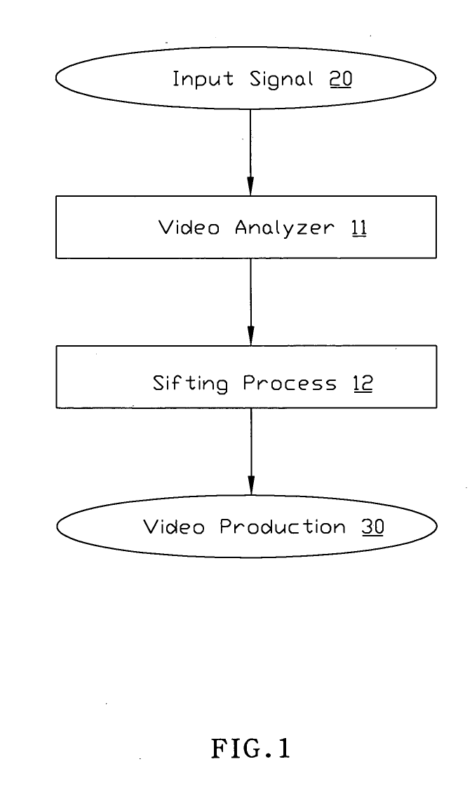

Referring to FIG. 1, Input signals 20 include one or more pieces of media, which is presented as an input to the system. Supported media types, without limitation, include video, image, slideshow, animation and graphics.

Video analyzer 11, extracts the information embedded in media content, like time-code, duration of media, and measures the rate of change and statistical properties of other descriptors, descriptors derived by combining two or more other descriptors, etc. For example, video analyzer 11 measures the probability that a segment of the input video contains a human face, probability that it is a natural scene, etc. In short, video analyzer 11 receives input signals 20 and outputs data with associated descriptors, which describes characteristics of input signals 20.

In one embodiment, the data with the associated descriptors are utilized in the next steps in sifting process 12. First, multitudes of weights are determined based on the associated descriptors. Second, for the acquirement of video production 30 with good quality, the data are adjusted based on at least one of the associated descriptors and weights. Third, the adjusted data are constructed for a video production 30. All blocks are described in detail as follows.

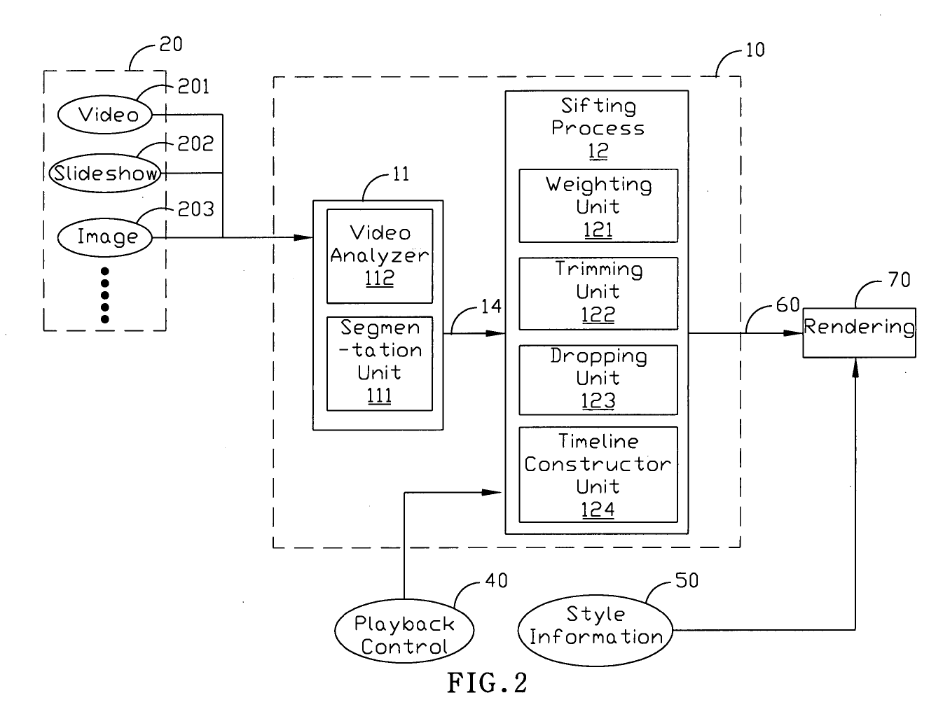

FIG. 2 is a schematic block diagram illustrating video data editing system of one embodiment in accordance with this invention. First, the video data editing system 10 receives video input signals 20 and playback control 40, and generates video production 60. The term “video input signal” refers to input signal of any video type including video, slideshow, image, animation, and graphics, and inputs as a digital video data file in any suitable standard format, such as DV video format. In an alternate embodiment, an analog video input signal may be converted into a digital video input signal used in the method.

In one embodiment, video input signals 20, without limitation, include video input 201, sideshow 202, image 203, etc. In the embodiment, video input 201 is typically unedited raw footage of video, such as video captured from a camera or camcorder, motion video such as a digital video stream or one or more digital video files. Optionally, it may include an audio soundtrack. In the embodiment, the audio soundtrack, such as people dialogue, is recorded simultaneously with video input 201. Slideshow 202 refers to a video signal including an image sequence, background music and property. Images 203 are typical still images such as digital image files, which are optionally used in addition to motion video.

In addition to video input signals 20, other constrains, such as playback control 40, may be inputted into video data editing system 10 for video production 60 with good quality.

Next, video data editing system 10 includes video analyzer 11 and sifting process 12. In one embodiment, video analyzer 11 is configured for generating analyzed data and descriptors 14 by analyzing video input signals 20. Furthermore, video analyzer 11 is configured for segmenting video input signals 20 according to video descriptors thereof. Video input signals 20 are first parameterized by any typical methods, such as frame-to-frame pixel difference, color histogram difference, and low order discrete cosine coefficient difference. Then video signals 20 are analyzed for acquiring analyzed video data and associated descriptors.

Typically, various analysis methods to detect segment boundary are used in video analyzer 11, such as scene change detection, checking similarity of video frames, segments, such as over-exposure, under-exposure, brightness, contrast, video stabilization, motion estimation etc., and determining the importance of video segments, checking skin color and detecting faces, flash (camera flash), dialog attached with video-content, face recognition etc. The analyzed descriptors in video analyzer 11 include typically measures of brightness or color such as histograms, measures of shape, or measures of activity. Furthermore, the analyzed descriptors include durations, qualities, importance and preference descriptors for the analyzed video data. Alternatively, soundtrack derived from the video input 201 can be used as a descriptor for further process. Then, the segmentation performed by video analyzer 11, for example, is based on scene change detection, camcorder shooting time, or turn on/off from camcorder to improve video segmentation result and generates one or more video segments. The video segment is a sequence of video frames or a part of a clip that is composed one or more shots or scenes.

It is noted that video input signals 20 with MPEG-7 format contain some video descriptions, such as measures of color including scalable, color layout, dominant color, and measure of motion including motion trajectory and motion activity, camera motion and face recognition, etc. With the descriptions derived from one file in MPEG-7 format, such video input signals 20 may be used for further process, instead of process of video analyzer 11. Accordingly, the descriptions derived from the file in MPEG-7 format would be used as analyzed video descriptors mentioned in the following processes.

Next, analyzed data and associated descriptors 14 output to sifting process 12 for determining multitudes of weights, adjusting analyzed data and constructing adjusted data. In one embodiment, without limitation, analyzed data include multitudes of segments, and sifting process 12 includes weighting unit 121, trimming unit 122, dropping unit 123 and timeline constructor unit 124.

In weighting unit 121, multitudes of weights (“Wi” for descriptor “i”) are determined with some associated descriptors. In the embodiment, weighting unit 121 determines or assigns one descriptive score such as “frame-based” score (“S(Vi)” for descriptor “i”) to individual associated descriptor related to frames in each analyzed data, without limitation, such as those analyzed descriptors acquired by checking similarity of video frame, dialog analysis or face detection. For example, with face detection for one analyzed data such as one video segment, one or more associated face-characteristic descriptors are assigned or acquired higher scores (“S(Vi)”), respectively. Thus, within one video segment, some frames with more face-area have priorities for video production 60. On the other hand, weighting unit 121 also determines or assigns another descriptive score such as “segment-based” score to individual associated descriptor related to one analyzed data, without limitation, such as those analyzed descriptors acquired by analyzing video quality, analyzing unsteady segments or face detection. For example, with face detection for analyzed data such as some video segments, one or more associated face-characteristic descriptors are assigned or acquired higher scores (“S(Vi)”), respectively. Thus, within one video signal, one or more video segments with more face-area have priorities for video production 60.

Alternatively, with an “attention” curve, weighting unit 121 matches one “duration-based” score for each analyzed data, such as each video segment. In general, when users are trying to capture the attention of an audience, it's often easier to give them a lot of short video clips instead of attempt to appeal to their artsy side with long, drawn out shots of over 2 minutes long apiece. Shots of 5 to 8 seconds duration often work very well. Thus, in weighting unit 121, high “duration-based” score is assigned to one analyzed data such as one video segment with segment duration of 5 to 8 seconds. It is understandable one video segment with segment duration too short or too long will acquire lower “duration-based” score. Accordingly, weighting unit 121 determines or assigns scores to the associated descriptors, in which these scores express quality-related or duration-related characteristics for the analyzed data.

Next, trimming unit 122 is configured to adjust one video segment. Basically, one video segment is adjusting by trimming (excluding) some frames within the video segment. Such adjustment is implemented based on one or more associated descriptors with their “frame-based” scores (“S(Vi)”). In the embodiment, the associated descriptors with their frame-based scores are usually characteristics related to multitudes of frames within the video segment. For one video segment, some frames or clips are trimmed based on the associated descriptors with lower “frame-based” scores. Thus, with trimming adjustment, one video segment consists of frames with good qualities. Furthermore, the trimmed video segment may have a trimmed segment duration different from the original video segment duration. In an alternative embodiment, some frames or shots are trimmed due to constraints by playback control 40.

For example, with using soundtrack as a descriptor in trimming unit 122, some sequential frames, especially in the midst of one “dialog” segment, are with higher “soundtrack” scores, individually. On the other hand, some frames, especially at the beginning or end of the “dialog” segment, are with lower “soundtrack” scores, individually. The frame where the introduction of the soundtrack is can be marked as the beginning of trimming “trim in” , and the frame where the completion of the soundtrack is can be marked as the ending of trimming “trim out”. Those frames positioned between “trim in” and “trim out” are retained. Thus, the frames positioned at the beginning or end of the “dialog” segment will be trimmed in trimming unit 122. It is noted that a trimmed range for those marked trimmed frames is applied while multitudes of “frame-based” scores are considered. It is due to those marked trimmed frames may be different based on different associated descriptors with “frame-based” scores. Thus, with adjustment of the trimmed range, some marked trimmed frames are determined to trim out.

On the other hand, in dropping unit 123, the video segments, with or without frame-based adjustment, can be adjusted based on the associated descriptors with “segment-based” scores, the “duration-based” scores, playback control 40, or all of them. Dropping unit 123 is configured to adjust some video segments of the analyzed data. Basically, one video segment is wholly dropped (excluded) in dropping unit 123 on the ground that there are the associated descriptors with the lower “segment-based” scores, the lower “duration-based” scores, or both of them.

In one embodiment, “segment-based” scores are further multiplied by quality-related weights, respectively, and further summarized to acquire one “quality-related” score for each video segment as follows:

$$S ( Qj ) = {\sum }_{i = 1}^{N} Sj ( Vi ) * Wi$$

Where “N” is the total number of descriptors; “i” represents descriptor index; “Vi” is a segment “j” with descriptor “i”; “Wi” represents a quality-related weight for descriptor “i”; “Sj(Vi)” is score of descriptor “i”for one segment “j”; and “S(Qj)” is one “quality-related” score for each video segment “j”.

Then, multiplied by content-based weight and duration-based weight, respectively, the “quality-related” score and “duration-based” score are summarized to acquire one segment score for each video segment as follows:
Sj=W(Q)*S(Qj)+W(T)*S(Tj)

Where “S(Tj)” is the original segment duration or a trimmed segment duration for each video segment; “W(T)” means the duration-based weight; and “W(Q)” represents the content-based weight.

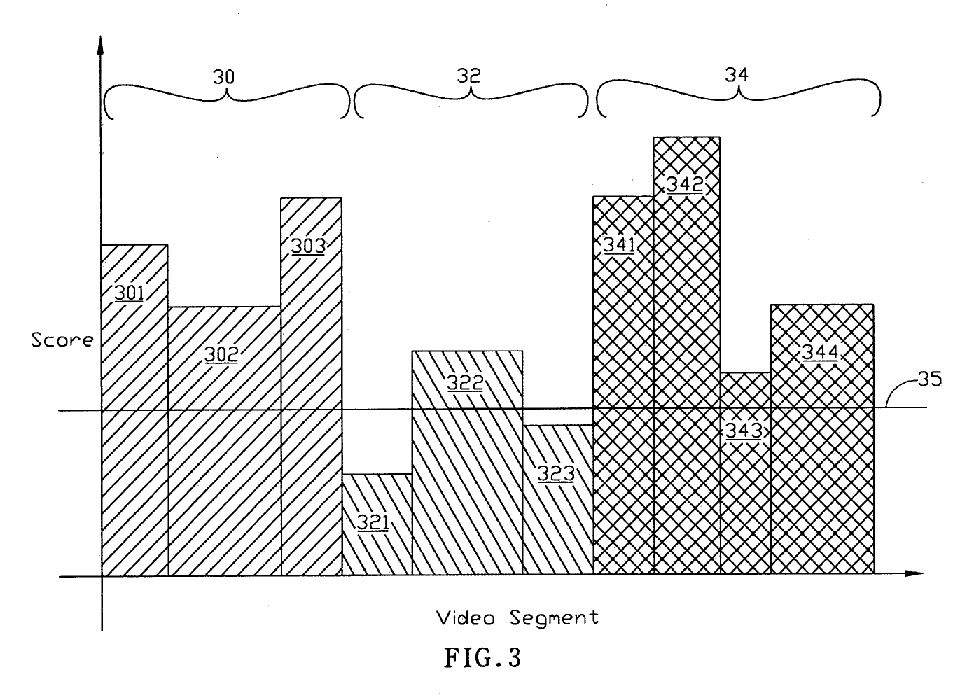

Shown in FIG. 3, clip 30 is divided into video segments 301,302,303, clip 32 into video segments 321,322,323, and clip 34 into video segments 341,342,343,344. Each video segment has a segment score (Sj). In dropping unit 123, with a score threshold 35, some video segments will be dropped, such as video segments 321 and 323. Accordingly, each segment score for each video segment is characterized by the “quality-related” score and “duration-based” score. Thus, one video segment with higher segment score plays one more important portion for the video production 60. It is understandable that one video segment with relative lower segment score may be dropped in dropping unit 123.

Alternatively, it is noted that the number of dropped video segments is also dependent on a production duration related to the video production 60. When the summed total duration of the video segments exceeds the production duration, the video segments with relative lower segment scores should be dropped. When the summed total duration of the video segments is less than the production duration, one or more video segments with relative higher segment scores may be repeated to meet the production duration. However, when the summed total duration is near to the production duration, the trimming step may be implemented within any one video segment to adjust the individual duration of one video segment. Additionally, the number of dropped video segments is also just dependent on qualities of the video production 60 without consideration of the predetermined production duration. That is, the summed total duration of the video segment after dropping in view of video qualities is acceptable, when user would like to show up the good quality video production, and do not mind the finial video production duration. Although both of production duration and quality constrain to produce the finial video production is workable.

Next, the adjusted data output to timeline constructor unit 124 for outputting video production 60. Timeline constructor unit 124 is configured for constructing the adjusted video data in sequence. Optionally, Timeline constructor unit 124 constructs video data with playback control 40.

Normally, video production 60 would be directly viewed and run by users. Of course, with style information template 50, video production 60 would input into render unit 70 for post processing. In the embodiment, style information 50 is a defined project template, without limitation, which includes descriptors as follows: filters, transition effects, transition duration, title, credit, overlay, beginning video clip, ending video clip, and text.

It will be clear to those skilled in the art that the invention can be embodied in many kinds of hardware device, including general-purpose computers, personal digital assistants, dedicated video-editing boxes, set-top boxes, digital video recorders, televisions, computer games consoles, digital still cameras, digital video cameras and other devices capable of media processing. It can also be embodied as a system comprising multiple devices, in which different parts of its functionality are embedded within more than one hardware device.

Although the invention has been described above with reference to particular embodiments, various modifications are possible within the scope of the invention as will be clear to a skilled person.

1. A method of video production editing, comprising:
receiving video data and a plurality of associated video descriptors, which describe characteristic of said video data;
determining a plurality of descriptive scores for said associated video descriptors, wherein at least one of said descriptive scores is corresponding to one of said associated video descriptors; and
adjusting said video data based on at least one of said descriptive scores to construct a video production.

2. The method of video production editing according to claim 1, wherein the receiving step comprises receiving a plurality of video segments and said associated video descriptors, and wherein each said video segment consists of a plurality of video frames.

3. The method of video production editing according to claim 2, wherein the adjusting step comprises dropping a portion of said video segments.

4. The method of video production editing according to claim 3, wherein the dropping step is implemented further based on production duration for said video production.

5. The method of video production editing according to claim 3, wherein the adjusting step further comprises, within one said video segment, trimming a portion of said frames in one said video segment.

6. The method of video production editing according to claim 5, wherein the trimming step is implemented further based on production duration for said video production.

7. The method of video production editing according to claim 2, wherein the adjusting step is implemented further based on production duration for said video production.

8. The method of video production editing according to claim 7, wherein the adjusting step comprises, for one said video segment, trimming a portion of said frames in one said video segment.

9. The method of video production editing according to claim 8, wherein the adjusting step further comprises dropping a portion of said video segments after the trimming step.

10. The method of video production according to claim 2, wherein the determining step comprises:
acquiring a quality-related score, for each said video segment, by summarizing a portion of said descriptive scores multiplied by a plurality of quality-related weights, respectively;
determining a duration-related score characterizing each said video segment; and
adding said quality-related score and said duration-related score multiple by content-based weight and duration-based weight for each said video segment for dropping a portion of said video segments in the adjusting step.

11. The method of video production according to claim 1, wherein said video data and said associated video descriptors are in format of MPEG-7.

12. The method of video production according to claim 1,.wherein the adjusting step is further based on at least one playback control and production duration for said video production.

13. A method of video data editing, comprising:
receiving a video signal;
analyzing said video signal to generate a plurality of video segments and a plurality of associated descriptors, which describe characteristic of said video signal, wherein each said video segment consists of a plurality of frames; and
sifting, based on said associated descriptors, at least one of a portion of said video segments and a portion of frames.

14. The method of video data editing according to claim 13, wherein the sifting step comprises:
determining a plurality of descriptive scores for a portion of said associated descriptors, which characterize said frames;
trimming said portion of said frames within any one of said video segments based on said descriptive scores and acquiring a trimmed segment duration for one said trimmed video segment;
determining a plurality of quality-related scores for a portion of said associated descriptors, which characterize each said video segment;
determining a duration-related score characterizing one of said trimmed segment duration and one said video segment duration;
acquiring a segment score for each said associated video segment by summing said quality-related scores multiplied by a plurality of content-based weights and said duration-related score multiplied by a duration-based weight; and
dropping a portion of said video segments based on said segment scores.

15. The method of video data editing according to claim 14, wherein the trimming and dropping steps are implemented further based on production duration for said video signal.

16. The method of video data editing according to claim 13, wherein the analyzing step further comprises extracting a soundtrack signal from said video signal to generate a soundtrack descriptor for the sifting step.

17. The method of video data editing according to claim 16, wherein the sifting step comprises:
determining a plurality of quality-related scores for a portion of said associated descriptors each that characterizes one said video segment;
determining a duration-related score characterizing each said video segment;
acquiring a segment score for each said associated video segment by summing said quality-related scores multiplied by a plurality of content-based weights and said duration-related score multiplied by a duration-based weight;
dropping a portion of said video segments based on said segment scores;
determining a plurality of descriptive scores for a portion of said associated descriptors which characterize a portion of said frames and said soundtrack descriptor; and
trimming said portion of said frames within any one of said video segments based on said descriptive scores.

18. A storage device, storing a plurality of programs readable by a media process device, wherein the media process device according to said programs executes the steps comprising:
receiving video data and a plurality of associated video descriptors, which describe characteristic of said video data;
determining a plurality of descriptive scores for said associated video descriptors, wherein at least one of said descriptive scores is corresponding to one of said associated video descriptors; and
adjusting said video data based on at least one of said descriptive scores to construct a video production.

19. A storage device, storing a plurality of programs readable by a media process device, wherein the media process device according to said programs executes the steps comprising:
receiving a video signal;
analyzing said video signal to generate a plurality of video segments and a plurality of associated descriptors, which describe characteristic of said video signal, wherein each said video segment consists of a plurality of frames;
determining a plurality of descriptive scores for a portion of said associated descriptors, which characterize said frames;
trimming said portion of said frames within any one of said video segments based on said descriptive scores and acquiring a trimmed segment duration for one said trimmed video segment;
determining a plurality of quality-related scores for a portion of said associated descriptors, which characterize each said video segment;
determining a duration-related score characterizing one of said trimmed segment duration and one said video segment;
acquiring a segment score for each said associated video segment by summing said quality-related scores multiplied by a plurality of content-based weights and said duration-related score multiplied by a duration-based weight; and
dropping a portion of said video segments based on said segment scores.

20. A storage device, storing a plurality of programs readable by a media process device, wherein the media process device according to said programs executes the steps comprising:
receiving a video signal;
analyzing said video signal to generate a plurality of video segments and a plurality of associated descriptors, which describe characteristic of said video signal, wherein each said video segment consists of a plurality of frames;
determining a plurality of quality-related scores for a portion of said associated descriptors each that characterizes one said video segment;
determining a duration-related score characterizing each said video segment;
acquiring a segment score for each said associated video segment by summing said quality-related scores multiplied by a plurality of content-based weights and said duration-related score multiplied by a duration-based weight;
dropping a portion of said video segments based on said segment scores and a production duration for a video product;
determining a plurality of descriptive scores for a portion of said associated descriptors which characterize said frames; and
trimming said portion of said frames within any one of said video segments based on said descriptive scores and said production duration for said video product.
